(19) United States
(12) Patent Application Publication
(10) Pub. No.: US 2013/0002066 A1
(43) Pub. Date: Jan. 3, 2013

(54) LIGHTWEIGHT AND EFFICIENT ELECTRICAL MACHINE AND METHOD OF MANUFACTURE

(75) Inventor: Geoffrey A. Long, Santa Barbara, CA (US)

(73) Assignee: LAUNCHPOINT TECHNOLOGIES, INC., Goleta, CA (US)

(21) Appl. No.: 13/634,636

(22) PCT Filed: Feb. 28, 2011
(86) PCT No.: PCT/US2011/026469

§ 371 Date: Sep. 13, 2012

Related U.S. Application Data
(60) Provisional application No. 61/328,858, filed on Apr. 28, 2010.

(51) Int. Cl. H02K 9/00; H02K 15/04; H02K 11/00; H02K 57/00; H02K 3/04; H02K 21/12

(52) U.S. Cl. 310/54; 310/180; 310/156.01; 310/68 R; 310/112; 29/596

(57) ABSTRACT

A lightweight and efficient electrical machine element including a method of manufacture providing a stator winding for an electric machine which has a large portion of its volume containing electrically conductive strands and a small portion of its volume containing of an encapsulant material. The stator winding includes winding of a first phase (90) by shaping a portion of a bundle of conductive strands into an overlapping, multi-layer arrangement. Winding of successive phases (91, 92) occurs with further bundles of conductor strands around the preceding phases constructed into similar overlapping, multi-layer arrangements. The multiple p (90, 91, 92) are impregnated with the encapsulant material using dies (60, 80) to press the bundles into a desired form while expelling excess encapsulant prior to the curing of the encapsulant material. The encapsulated winding is removed from the dies after the encapsulant has cured. The encapsulant coating on the strands may be activated using either heat or solvent. The stator winding may be pressed into a form which has cooling channels which increase the surface area, thus enhancing convective cooling, heat dissipation, and the electrical machine's efficiency.

A portion of this invention was invented under a contract with a Small Business Innovation Research (SBIR) grant, through the Defense Advanced Research Projects Agency (DARPA). The contract number for the grant was W31P4Q-09-C-0109 and it was administered by the U.S. Army Aviation and Missile Command.

### BACKGROUND OF THE INVENTION

This invention relates to electrical machinery such as motors and generators and more particularly to an electrical machine with an electrically commutated stator.

There are many applications which would benefit from an electric machine with reduced weight and high efficiency. Examples include electric aircraft propulsion, spacecraft mechanisms, wind turbine electricity generators, electrically propelled automobiles, etc.

Iron commonly constitutes a large portion of the weight of an electric machine. In the stator, iron is commonly used to shape the magnetic field and to transmit the torque of the device to the base of the machine. However, “coreless” electric machines do not have iron in the stator. In some cases, these coreless machines can result in an overall weight reduction due to their lack of iron.

Coreless machines must provide an alternative method for transmitting the torque of the machine to the base. The electrically conductive strands of which the stator is made do not generally have sufficient strength to transmit the torque themselves. A material such as epoxy or other adhesive is commonly used to encapsulate the stator electrical conductor strands to create a composite part with the required structural strength. The amount of encapsulant required to provide this structural strength is quite small, and excess encapsulant is detrimental both to dissipating heat out of the machine, and because it increases the weight of the machine. It is also desirable to maximize the amount of volume in the stator which is filled by the electrical conductor strands, which necessitates minimization of unnecessary encapsulant.

Careless machines sometimes use litz wire in the windings to reduce the eddy current losses in the conductors. Litz wire consists of many fine strands of electrically conductive material, such as copper, which are each coated with a thin layer of electrical insulation. The strands of litz wire are generally twisted or braided to reduce skin and proximity effects at high frequency.

In 1981, Klaus Halbach published a paper which described an arrangement of magnets which has since been commonly referred to as a “Halbach array”. A Halbach array consists of several magnet segments which each have a similar or identical shape, but which have a magnetic orientation which rotates by an increment from one segment to the next adjacent segment. The result is that the magnetic field of the array is concentrated on one side of the array and cancelled on the other side of the array without the need for a ferromagnetic material such as iron to shape the field. If the magnet segments are of identical shape and the orientation increment is a fixed value, the variation of the magnetic field on the concentrated side is approximately sinusoidal.

The concentrated nature of the magnetic field of a Halbach array makes them ideally suited for use in electrical machines such as motors and generators. In rotating machines, the Halbach array can be arranged as a cylinder with the field either substantially in the radial direction or substantially in the axial direction. Furthermore, there can be a Halbach array on both sides of the winding, or there may just be a Halbach array on only one side of the winding. Having a Halbach array on each side of the winding increases the useful magnetic field in the stator winding.

### SUMMARY OF THE INVENTION

Accordingly, it is an object of this invention to provide an improved stator winding for an electric machine which has a large portion of its volume comprised of electrically conductive strands and a small portion of its volume comprised of an encapsulant material.

It is further an object of this invention to provide a method for manufacturing said improved stator winding.

It is further an object of this invention to provide an electrical machine which makes use of said improved stator winding to improve efficiency and reduce weight.

To achieve the above and other objects of the invention, a method for manufacturing a stator winding according to one aspect of the invention includes the steps of winding a first phase by shaping a portion a bundle of conductive strands into an overlapping, multi-layer arrangement; winding successive phases with further bundles of conductor strands around the preceding phases into similar overlapping, multi-layer arrangements; impregnating the multiple phases with an encapsulant material; using dies to press the bundles into a desired form while expelling excess encapsulant prior to the curing of the encapsulant material; removing the encapsulated winding from the dies after the encapsulant has cured.

According to another aspect of the invention, a method for manufacturing a stator winding includes the steps of individually coating conductive strands with a layer of encapsulant adhesive which is partially cured but can later be heat or solvent activated; making a bundle of multiple of these encapsulant coated strands; winding a first phase by shaping a portion of the bundle into an overlapping, multi-layer arrangement; winding successive phases with further bundles around the preceding phases into similar overlapping, multi-layer arrangements; using dies to press the bundles into a desired form; activating the encapsulant coating on the strands using either heat or solvent; removing the encapsulated winding from the dies after the encapsulant has cured.

According to another aspect of the invention, the stator winding is pressed into a form which has cooling channels which increase the surface area, improving convective cooling and thus improving heat dissipation and the electrical machine's efficiency.

According to yet another aspect of the invention, the stator winding is pressed into a form which has minimal encapsulant and maximal electrically conductive material.

According to still another aspect of the invention, an electrical machine has a formed stator winding which is formed to have minimal encapsulant and a rotor which includes two magnet arrays which are a type of Halbach array.

According to yet another aspect of the invention, an electrical machine has a formed stator, a rotor which includes two Halbach arrays, and an arrangement of impeller features which pull surrounding air through the motor. The forced airflow improves the dissipation of heat from the stator winding.

### BRIEF DESCRIPTION OF THE DRAWINGS

FIG. 1 is a perspective view of a bundle of strands which has been wound into an overlapping, two layer arrangement according to an embodiment of the invention;

FIG. 2 is a perspective view of three bundles of strands which have been wound around each other in an overlapping, two layer arrangement as a preliminary step towards creating a three phase winding according to an embodiment of the invention;

FIG. 3 is a top view of the three phase winding of FIG. 2;

FIG. 4 is an enlarged cross-section view of the three phase winding of FIG. 3 along the line 4-4 thereof, which illustrates the relative arrangement of the three phases in the active area of the stator;

FIG. 5 is a perspective view of a bundle of strands with insulation partially unwound to expose the strands of which it consists;

FIG. 6 is a perspective view of a die with teeth features which is used to form a winding into a desired shape;

FIG. 7 is a top view of an assembly which is used to form a winding into a desired shape which includes cooling channels according to an embodiment of the invention, shown just prior to the forming stage of the process;

FIG. 8 is a cross-section view of the assembly of FIG. 7 along the line 8-8 thereof, which illustrates the relative placement of the winding with respect to the dies prior to the winding being formed;

FIG. 9 is an enlarged cross-section view of the assembly of FIG. 7 along the line 8-8 thereof, which illustrates the interleaving of the winding bundles between the teeth of one of the dies, prior to the winding being formed;

FIG. 10 is a top view of an assembly which is used to form a winding into a desired shape, shown just subsequent to the forming stage of the process;

FIG. 11 is a cross-section view of the assembly of FIG. 10 along the line 11-11 thereof, which illustrates the relative placement of the winding with respect to the dies subsequent to the winding being formed;

FIG. 12 is an enlarged cross-section view of the assembly of FIG. 10 along the line 12-12 thereof, which illustrates the approximately rectangular shape into which the bundles have been formed;

FIG. 13 is a top view of a formed and encapsulated winding which includes cooling channels, according to an embodiment of the invention;

FIG. 14 is a cross-section of the winding of FIG. 13 along the line 14-14 thereof;

FIG. 15 is an enlarged cross-section view of the winding of FIG. 13 along the line 15-15 thereof;

FIG. 16 is a top view of an assembly which is used to form a winding into a desired shape according to an embodiment of the invention, shown just prior to the forming stage of the process;

FIG. 17 is a cross-section of the assembly of FIG. 16 along the line 17-17 thereof, which illustrates the relative placement of the winding with respect to the dies prior to the winding being formed;

FIG. 18 is an enlarged cross-section view of the assembly of FIG. 16 along the line 18-18 thereof, prior to the winding being formed;

FIG. 19 is a top view of an assembly which is used to form a winding into a desired shape according to an embodiment of the invention, shown just subsequent to the forming and encapsulation stages of the process;

FIG. 20 is a cross-section of the assembly of FIG. 19 along the line 20-20 thereof;

FIG. 21 is an enlarged cross-section of the assembly of FIG. 19 along the line 21-21 thereof, illustrating the approximately rectangular shape into which the bundles have been formed, without a gap between adjacent phases;

FIG. 22 is a top view of a formed and encapsulated winding in which a large portion of the volume is filled with conductive strands and a small portion is filled with encapsulant or gaps;

FIG. 23 is a cross-section of the winding of FIG. 22 along the line 23-23 thereof;

FIG. 24 is an enlarged cross-section of the winding of FIG. 23 along the line 24-24 thereof, illustrating the high ratio of volume which the bundles occupy;

FIG. 25 is an enlarged cross-section of the winding of FIG. 22 along the line 25-25 thereof, illustrating the high ratio of volume which the bundles occupy and the lack of gaps between adjacent phases;

FIG. 26 is a top view of an electrical machine according to an embodiment of the invention, which consists of magnet arrays and a formed and encapsulated winding according to an embodiment of the invention;

FIG. 27 is a cross-section of the electrical machine of FIG. 26 along the line 27-27 thereof, which illustrates the relative placement of the winding and magnet arrays, among other components according to an embodiment of the invention;

FIG. 28 is an enlarged cross-section of the electrical machine of FIG. 26 along the line 28-28 thereof, which illustrates the orientation of magnets within the magnet arrays, according to an embodiment of the invention;

FIG. 29 is an exploded perspective view of an electrical machine according to an embodiment of the invention which includes impellers which pull surrounding air through the device in order to aid cooling;

FIG. 30 is a perspective view of a magnet array whose magnets include features which act as impeller features to pull surrounding air through to device to aid cooling.

### DETAILED DESCRIPTION

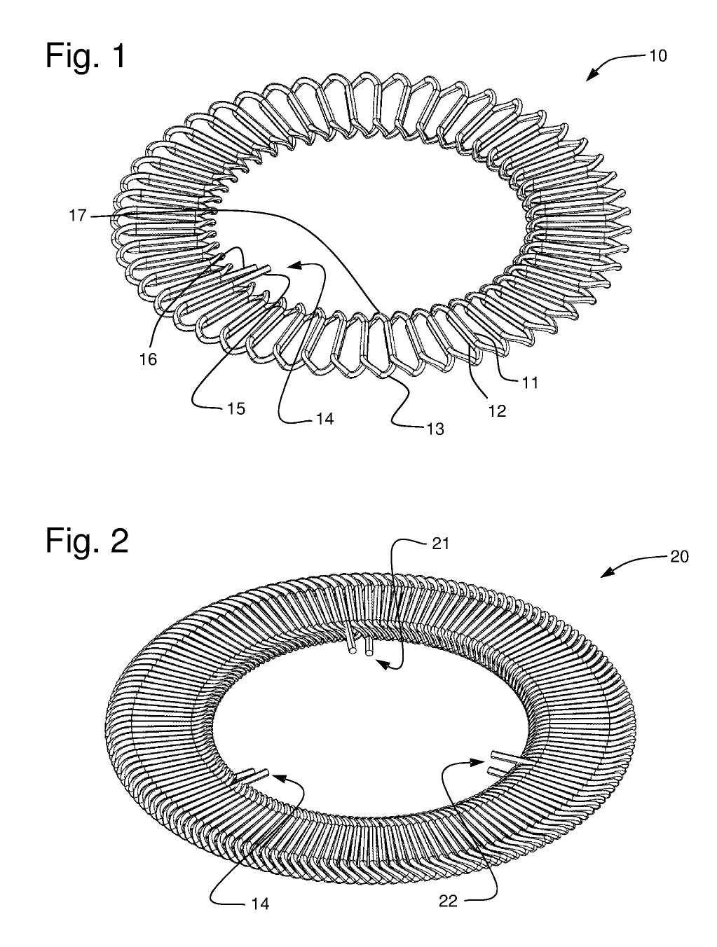

Referring now to the drawings wherein like reference numerals designate corresponding structure throughout the views, and referring in particular to FIG. 1, a first phase 10 according to one embodiment of the invention is made from a bundle of conductive strands. The bundle is wound into a shape which has a first layer 11, which is adjacent to a second layer 12. The bundle is wound starting from a first terminal 15 in the first layer and is shaped into an outer end turn 13 which places it in the second layer, then an inner end turn 17 places it back in the first layer. The winding of the phase continues in the clockwise direction, alternating between the first and second layers, until both the first and second layers are filled and the bundle ends with a second terminal 16. When the first phase is used in an electric machine, the terminals 14 consisting of the first terminal 15 and second terminal 16 are used to pass current through the first phase to generate torque. In alternative embodiments, the first phase can be sectioned into multiple portions with multiple terminals rather than consisting of a single bundle of strands as depicted by 10.

While the embodiment depicted in FIG. 1 consists of a single turn, alternative embodiments can consist of multiple turns. Each successive turn repeats the same pattern as the first turn and is adjacent to the preceding turns. In still further alternative embodiments, each phase is subdivided into portions of a turn. The advantage of subdividing the phase is to reduce the back EMF or to allow for redundancy.

Referring now to FIG. 2, according an embodiment of the invention, a three phase winding 20 is wound by winding a second phase with terminals 21 and a third phase with terminals 22 around the first phase with terminals 14 in a similar manner as the first phase 10 shown in FIG. 1. In an alternative embodiment, the winding can consist of four or more phases.

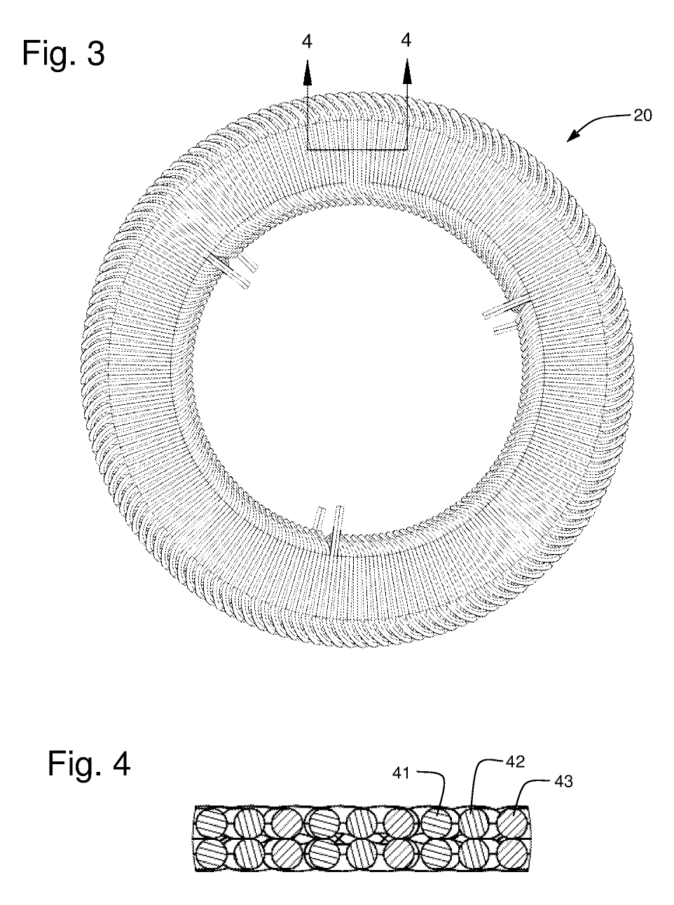

The three phase winding 20 is also depicted in FIG. 3 which defines the line 4-4 along which the cross-section of FIG. 4 is taken. As shown in FIG. 4, the three phases are interleaved with a first phase 41 being adjacent to a second phase 42 and a third phase 43. According to the preferred embodiment of the invention, the first layer of each phase is located directly above the second layer, corresponding to a zero degree electrical shift between the two layers. However, in alternative embodiments, the first and second layers can be offset from each other by up to 90 electrical degrees.

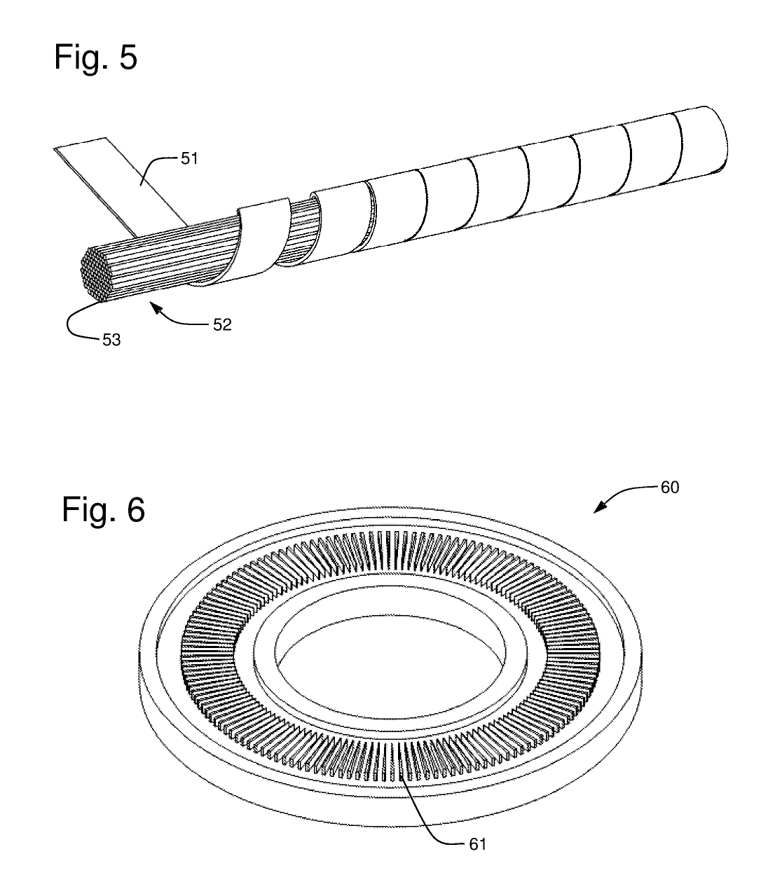

Referring now to FIG. 5, a bundle of conductive strands 52 is depicted. The bundle of conductive strands 52 consists of conductive strands 53 which are wrapped with a serving material 51 which keeps the strands bound together and provides electrical insulation between adjacent bundles when formed into a winding. According to a preferred embodiment, the serving material 51 consists of nylon textile yarn. However, in alternative embodiments, the serving material 51 may consist of heat shrink tubing or aramid fiber yarn. According to a preferred embodiment of the invention, the conductive strands are manufactured from copper and are individually coated with an electrically insulating material such as polyurethane. However, in alternative embodiments, the conductive material is replaced with another metal such as silver or aluminum. In still further alternative embodiments, the electrically insulating coating can be either omitted, replaced with an alternative material such as polyimide, or be augmented with a top coating of heat or solvent activated adhesive coating. A heat or solvent activated adhesive coating allows the bundle to remain flexible during the winding process, but creates a rigid part after winding is complete and the adhesive coating is activated by application of heat or solvent.

The bundle of strands 52 is relatively compliant prior to being encapsulated and can be bent into a variety of shapes. Its cross-sectional shape can also be formed into a variety of shapes prior to being encapsulated. However, due to its compliant nature, the bundle of strands will not generally retain these shapes until the bundle is encapsulated as described below.

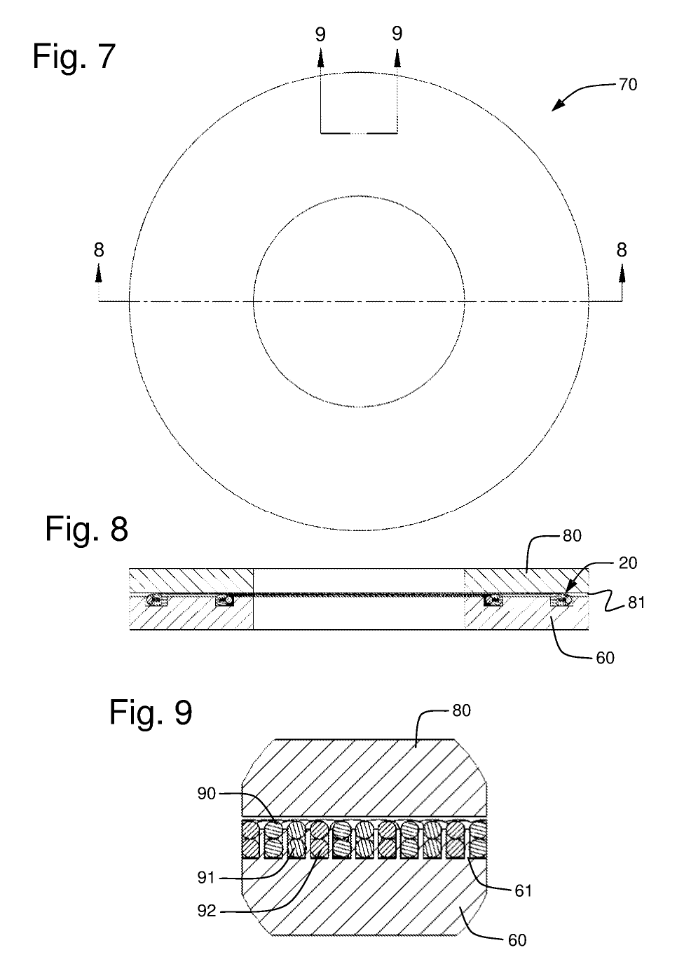

Referring briefly now to FIG. 6, a toothed die 60 is depicted which includes teeth features 61. Referring now to FIG. 7, according to an embodiment of the invention an un-pressed forming assembly 70 is depicted. The lines 8-8 and 9-9 in FIG. 7 define the cross-section views of FIG. 8 and FIG. 9 respectively. Referring now to FIG. 8, the un-pressed forming assembly 70 is shown prior to the forming of the winding such that the toothed die 60 is separated from a smooth die 80 by a gap 81. The three phase winding 20 is shown situated between the toothed die 60 and the smooth die 81. Referring now to FIG. 9, it can be seen that the teeth features 61 of the toothed die 60 are interleaved between the first phase 90, the second phase 91, and the third phase 92 of the three phase winding 20. At this stage, the cross sections of the phases 90-92 are in a relaxed state and are approximately round.

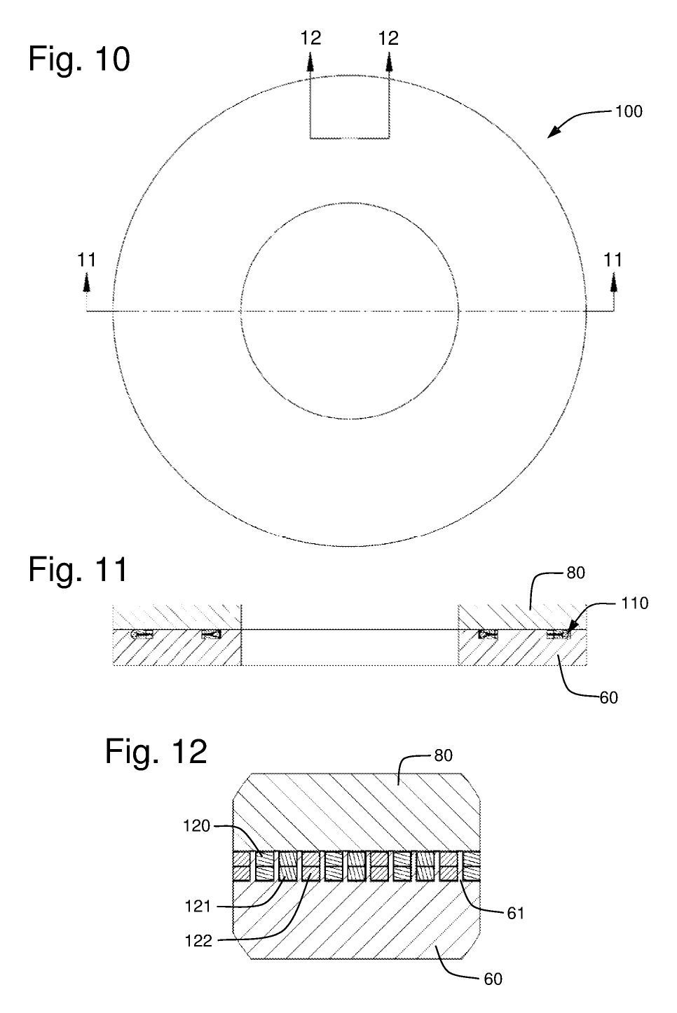

By pressing the smooth die 80 and the toothed die 60 together, the winding 20 can be formed into a shape that is defined by the shapes of faying surfaces of the dies. FIG. 10 shows the pressed forming assembly 100, which is created by pressing the smooth die 80 and the toothed die 60 of the un-pressed forming assembly 70 together, until the gap 81 is eliminated. The lines 11-11 and 12-12 in FIG. 10 define the cross-section views of FIG. 11 and FIG. 12, which depict further detail. In FIG. 11, the formed winding 110 is shown pressed between the smooth die 80 and the toothed die 60. In FIG. 12, the cross-sections of the three phases 120-122 are now approximately rectangular as a result of pressing the forming operation.

According to a preferred embodiment, an encapsulant material can next be vacuum impregnated into voids between the individual strands and between the two dies. However, according to another embodiment, encapsulant material could have been impregnated into the voids of the un-pressed forming assembly 70 prior to the forming operation. According to still another embodiment, an injection molding process is used to impregnate the assembly with encapsulant.

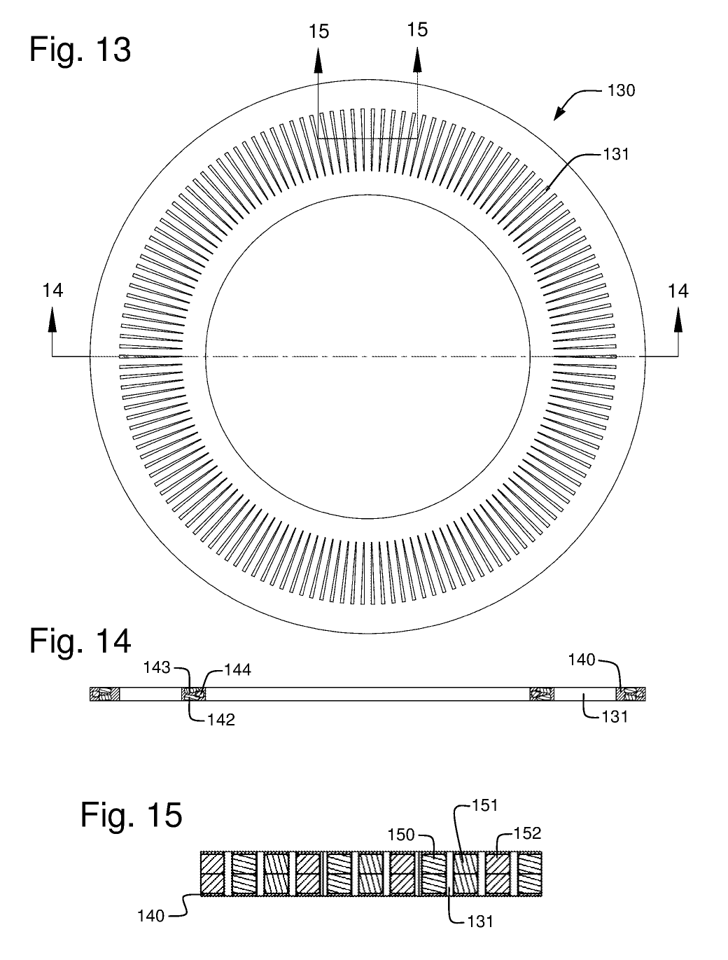

Referring now to FIG. 13, a formed and encapsulated winding 130 is depicted after the encapsulant material has cured and after it has been removed from the pressed forming assembly 100. Cooling channels 131 have been formed where the teeth 61 of the toothed die 60 once were. These cooling channels increase the surface area from which heat can be extracted from the winding during operation of the electrical machine, thus reducing the operation temperature of the machine and improving efficiency. The lines 14-14 and 15-15 define the cross-section views of FIG. 14 and FIG. 15 respectively. In FIG. 14, the cross sections of the three phases 142-144 are shown along with the small amount of excess encapsulant 140. In FIG. 15, the cross sections of the three phases 150-152 are depicted, which have retained their approximately rectangular shape due to the encapsulant material which has made them structurally rigid and strong.

According to an alternative embodiment of the invention, the channels 131 which have been formed into the winding 130 can be filled with a stiffening or strengthening material such as titanium, carbon fiber composite, a carbon nanotube composite, sapphire, ceramic, etc.

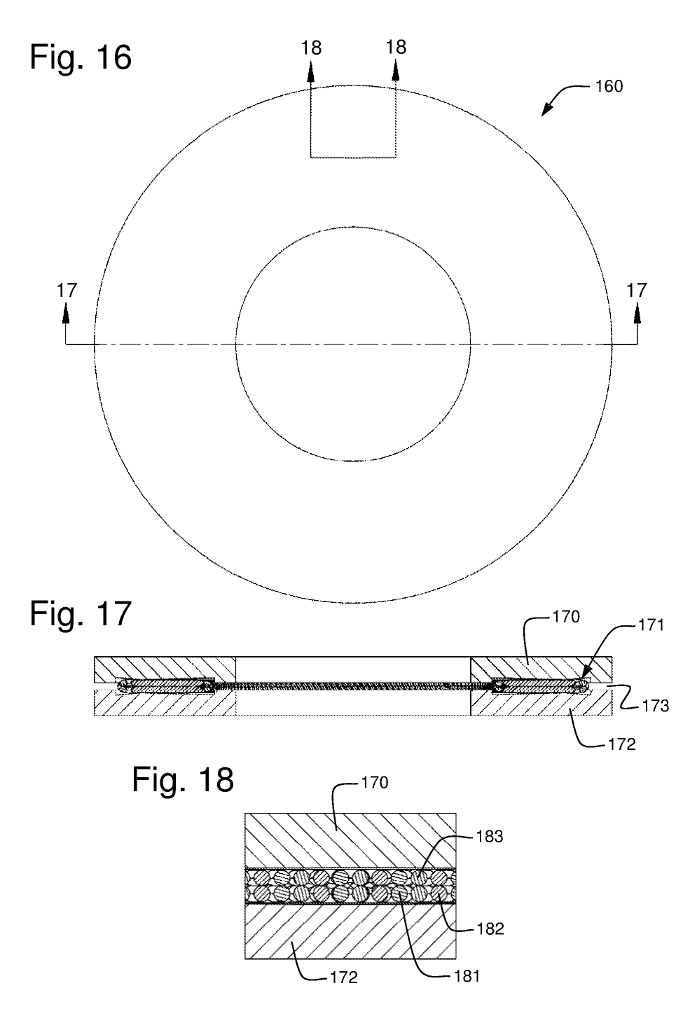

According to an alternative embodiment of the invention, a winding can be made to have maximal conductor volume and without cooling channels. An un-pressed forming assembly 160 corresponding to this alternative embodiment is shown in FIG. 16. The lines 17-17 and 18-18 in FIG. 16 define the cross-sections of FIG. 17 and FIG. 18 respectively, which contain further detail. The un-pressed forming assembly 160 consists of a three phase winding 171 and two dies 170 and 172 which in this embodiment of the invention do not have teeth as the toothed die 60 did. At this stage, there is a gap 173 between the two dies 170 and 172. The tapered faces of the dies are designed such that they form the phase bundles into a tapered shape with no cooling channels, but with maximal volume occupied by conductive strands. This shape has improved efficiency and torsional stiffness compared the shape which included cooling channels. As shown in FIG. 18, the three phases 181, 182 and 183 are interleaved with a gap between them.

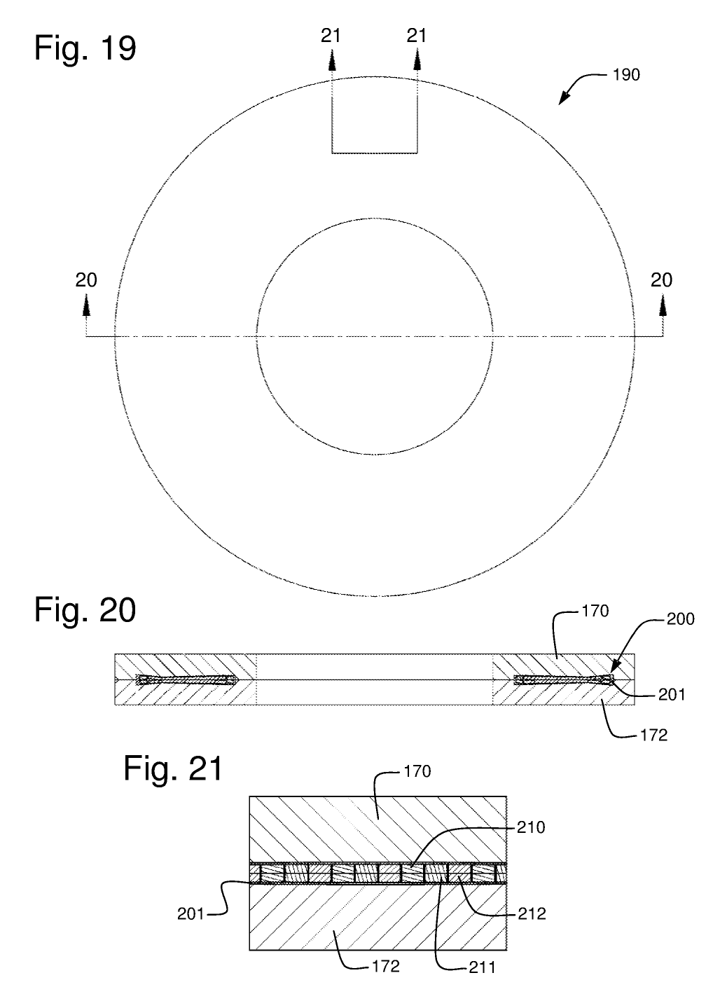

Referring now to FIG. 19, the pressed forming assembly 190 is shown which corresponds to the un-pressed forming assembly 160 after the pressing process and encapsulation process have been performed. The lines 20-20 and 21-21 in FIG. 19 define the cross-sections of FIG. 20 and FIG. 21 respectively. As shown in FIG. 20, the two dies 170 and 172 have now been pressed together, such that the gap 173 has been closed and no longer exists. The formed and encapsulated winding 200 now has the desired tapered shape with minimal excess encapsulant 201. As shown in FIG. 21, the three phases 210, 211 and 212 now have rectangular cross sections and there is no gap between them.

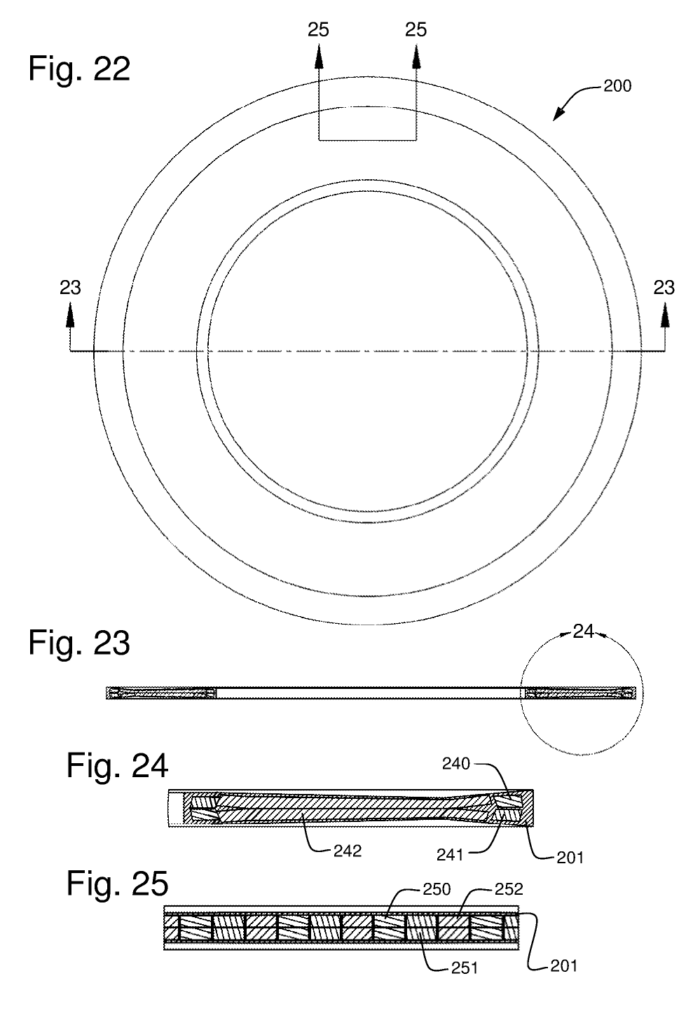

Referring now to FIG. 22, the formed and encapsulated tapered winding 200 is shown after it has been removed from the dies 170 and 172. The lines 23-23 and 25-25 in FIG. 22 define the cross-sections of FIG. 23 and FIG. 25 respectively. The line 24-24 in FIG. 23 defines an additional FIG. 24. As shown in FIG. 24, the phase bundle has been presses such that the thickness on the left-hand side is larger than the thickness on the right-hand side. Furthermore, the aspect ratio between the thickness and the width of the bundle varies along its length in such a way as to maximize the amount of conductive material in the winding and minimize the amount of encapsulant. The two other phases 240 and 241 are shown as they cross over the phase 242 which is cut by the viewing plane in the end turns. Only a small amount of excess encapsulant 201 remains.

Referring now to FIG. 25, the cross-sectional shapes of the three phases 250, 251 and 252 have retained their formed shape due to the adhesion of the encapsulant after having been removed from the dies 170 and 172. The three phases 250, 251 and 252 have an approximately rectangular shape with only a minimal amount of space between them occupied by serving and excess encapsulant material. Only a small amount of encapsulant 201 remains on the top and bottom surface and in between the phases.

While the windings described up to this point, the winding with cooling channels 130 and the tapered winding with maximal conductive material 200, both have a flat and disk-like form which is suitable for use in axial-flux electrical machines, alternative embodiments of the invention include cylindrical windings which would be suitable for radial-flux electrical machines. Still further embodiments of the invention include windings with a conical shape which are suitable for conical-flux electrical machines.

Some of the steps, shapes and features described above and depicted in FIG. 7 through 25 can be rearranged or interchanged to produce variations in the process and finished product. All of these variations are alternative embodiments of the invention.

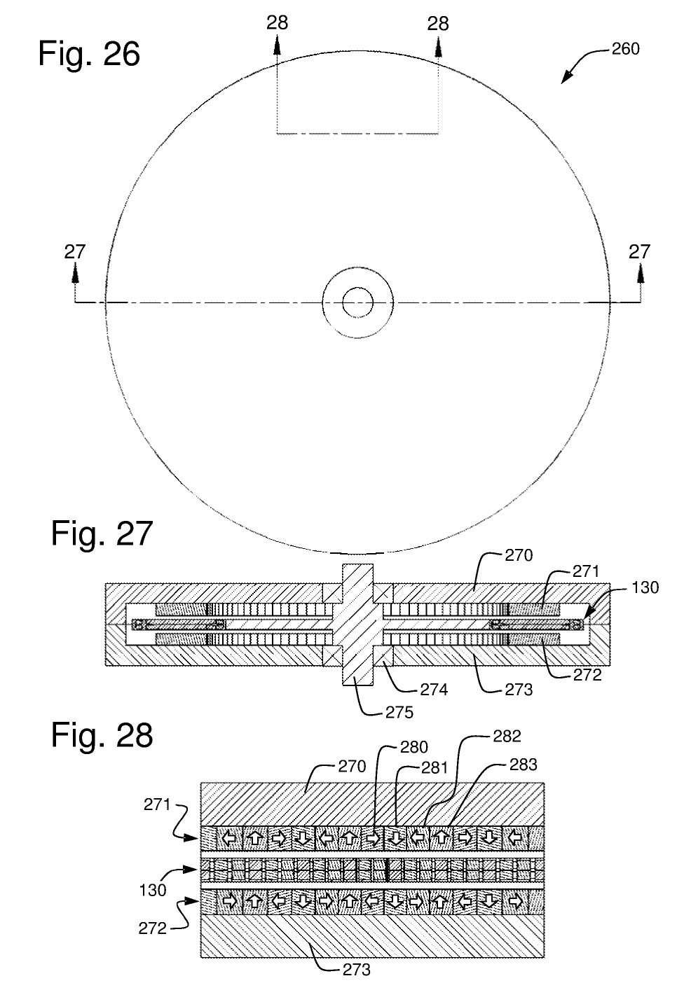

Referring now to FIG. 26, an electrical machine 260 is depicted. The lines 27-27 and 28-28 define the cross-sections of FIG. 27 and FIG. 28 respectively. According to a preferred embodiment of the invention, the machine 260 consists of a formed and potted winding 130 which is a component of the stator 275 which consists of all of the parts which are stationary during operation of the machine. The rotor consists of all of the parts which rotate during operation of the machine, which are the housings 270 and 273 and magnet arrays 271 and 272. The rotor and stator are connected by means of a bearing 274.

Referring now to FIG. 28, the magnetic orientation of the individual magnets of the magnet arrays 271 and 272 are shown with block arrows. The magnet arrays consist of a repeated pattern of four magnet orientations 280, 281, 282 and 283. Each repeated section of magnets is referred to as a “cycle”. The relative angle of orientation of one magnet with respect to the adjacent magnets is 90 degrees. This type of magnet array is sometimes referred to as a Halbach array.

While the electrical machine 260 is shown with a winding 130 which includes cooling channels, an alternative embodiment of the invention would replace it with a tapered winding 200 or any other winding variation that is itself an embodiment of this invention. Also, while the electrical machine 260 is shown with a magnet array with four magnets per cycle, an alternative embodiment of the invention would use an array with 6 magnets per cycle with an angle increment between magnets of 60 degrees. Another alternative embodiment of the invention would use an array with 8 magnets per cycle with an angle increment between magnets of 45 degrees. Further alternative embodiments are possibly by making similar variations on the number of magnets per cycle.

In FIG. 28, while each of the 4 magnets in each cycle are shown as having similar size, an alternative embodiment of the invention consists of magnet arrays which have some magnets in each cycle larger than others. By varying the size of the magnets, the shape of the magnetic field can be changed from approximately sinusoidal to approximately trapezoidal. In some applications, an electric machine with trapezoidal magnetic field will have reduced ripple torque.

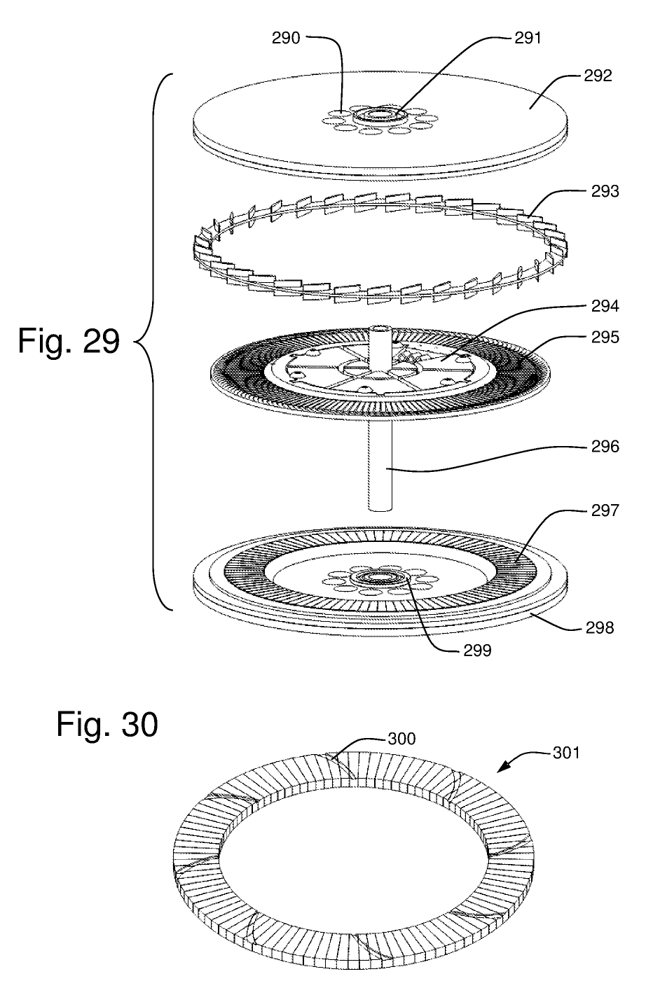

Referring now to FIG. 29, an exploded view of a preferred embodiment of the invention is depicted. This embodiment is similar to that of the electrical machine 260 with variations that improve the cooling performance of the device. The rotor of the machine consists of magnet arrays mounted to backing plates 292 and 298, and an impeller ring 293. The stator consists of a winding 295 which is mounted to a hub 294 which is mounted to a stationary shaft 296. The rotor is connected to the stator by means of bearings 291 and 299 which allow rotational motion between the rotor and stator. During operation of the machine, a pressure differential is generated across the impeller ring 293 which pulls surrounding air into the machine through inlet holes 290. The airflow aids the cooling of the machine by means of forced convection.

In an alternative embodiment of the invention, the hub 294 is comprised of a circuit board with the electronic components required to drive the machine. Using the hub as a circuit board reduces weight by giving the hub a dual use and it also allows the cooling air being pumped through the machine to be used to cool the electronic components.

In an alternative embodiment of the invention, the magnet array with smooth surface 297 is replaced with a magnet array 301 which has impeller features 300 in its face as shown in FIG. 30. The impeller features can be manufactured by removing material from the magnets, or they can be manufactured by adding a material such as epoxy or plastic to the face of the magnets.

Even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A winding of an electric machine, comprising:
two or more phases;
each phase consisting of a bundle of conductive strands which has been shaped into an overlapping, multi-layer arrangement and which has been pressed into a desired form;
encapsulant material which has been impregnated between the conductive strands.

2. The winding of claim 1 wherein the form is flat and disk-like.

3. The winding of claim 1 wherein the form is cylindrical or conical.

4. The winding of claim 1 wherein the winding phases are comprised of one or more turns.

5. The winding of claim 1 wherein each phase is subdivided into two or more sub-phases, each with their own terminals.

6. The winding of claim 1 with two layers which are shifted with respect to each other by from zero to 90 electrical degrees.

7. The winding of claim 1 wherein the encapsulant material is selected from the following: pure epoxy resin, epoxy resin filled with glass fibers, epoxy resin filled with carbon fiber, epoxy resin filled with carbon nanotubes, polyimide, polyetherimide, thermosetting polymer.

8. The winding of claim 1, wherein the cross-section of the winding bundles has an aspect ratio which varies from one end of the gap to the other.

9. The winding of claim 1, wherein the bundles are formed into a shape which includes channels which allow increased surface area for cooling.

10. The winding of claim 1 wherein the stiffness is augmented by adding stiffening material in channels formed between each winding bundle.

11. The winding of claim 1 wherein the stranded conductors are insulated from other strands within the same phase.

12. The winding of claim 1 wherein the bundles are made from litz wire.

13. The winding of claim 1 wherein the conductive strands are made from copper, silver, aluminum, or carbon nanotubes.

14. The winding of claim 1, wherein the conductive strands are interspersed with strands of a stiffer or stronger material such as carbon fiber, carbon nanotubes or aramid fibers.

15. A method for manufacturing the winding of claim 1 wherein:
dies are pressed together around a winding in order to form it into the desired shape;
encapsulant is impregnated into the winding while it is being pressed into the desired shape;
the winding is removed from the dies after the encapsulant has cured.

16. The method of claim 15 wherein the conductive strands are coated with a heat or solvent activated adhesive coating prior to being shaped or formed.

17. The method of claim 15 wherein the windings are formed by means of dies which are pressed together with more than 100 pounds of force per square inch of pressed winding.

18. The method of claim 15 wherein the winding is placed in a vacuum to aid impregnation of the encapsulant into the winding.

19. The method of claim 15 wherein an injection molding or compression molding process is used to impregnate the winding with encapsulant.

20. An electric machine, comprising:
a rotor which includes two magnet arrays separated by a gap;
each of said magnet arrays comprised of magnet segments, each of which has a magnetization direction that is rotated relative to the adjacent magnets by an increment such that the peak magnetic field in the gap is larger than that outside the gap;
a stator which includes the winding of claim 1 located in the gap between said rotor magnet arrays.

21. The electric machine of claim 20 wherein the number of magnet segments per magnetic cycle is either 4, 6 or 8 with angle increments of 90 degrees, 60 degrees or 45 degrees respectively.

22. The electric machine of claim 20 wherein the size of the magnets within a cycle are not all equal.

23. The electric machine of claim 20 wherein each of the magnet arrays is mounted onto housings made from a carbon fiber composite, a carbon nanotube composite or a titanium alloy.

24. The electric machine of claim 20, wherein the gap between the magnet arrays varies from one end of the gap to the other end.

25. The electric machine of claim 20, wherein the control electronics are packaged on the stator, within the rotor of the electric machine.

26. The electric machine of claim 25, wherein the printed circuit board, heat sink, or other part of the control electronics is used as a structural member to support the winding.

27. The electric machine of claim 25, wherein coolant such as air or liquid is used to remove heat from both the electrical machine and the control electronics.

28. An electric machine comprised of multiple electrical machines of claim 20 aggregated together to work as one machine.

29. The electric machine of claim 20, wherein an array of impellers on the rotor pull a fluid such as air, water or oil through the machine for cooling.

30. The electric machine of claim 20, wherein channels are cut into or added onto the face of the magnet arrays to act as a centrifugal pump to induce a cooling fluid such as air or a liquid to flow adjacent to the winding.
